(19) United States
(12) Patent Application Publication
(10) Pub. No.: US 2007/0051457 A1
(43) Pub. Date: Mar. 8, 2007

(54) Fabrication of multi-part sub-assemblies

(76) Inventor: Frank Matich, Bayview, New South Wales (AU)

Correspondence Address: DAVID A. GUERRA;INTERNATION PATENT GROUP, LLC, 2025 17TH AVENUE N.W., CALGARY, AB, T2M 0S7, CA

(21) Appl. No.: 10/596,078

(22) PCT Filed: Dec. 11, 2004
(86) PCT No.: PCT/AU04/01559

§ 371 Date: May 29, 2006

(30) Foreign Application Priority Data
Dec. 17, 2003 (AU) 2003907010
Dec. 17, 2003 (AU) 2003-907010

(51) Int. Cl. B32B 37/00

(52) U.S. Cl. 156/213; 156/308.2

(57) ABSTRACT

A process for encapsulating assemblies (21,41) from a plurality of sub-assemblies (1, 10; 32) is disclosed. Each sub-assembly is in turn formed by at least partial encapsulation thereby avoiding the need to glue, nail or otherwise secure the individual components (2-4, 11-12, 15; 31) of the sub-assemblies in place. The subassemblies can be easily stored and/or manipulated prior to the subsequent encapsulation step. The fabrication of a cable tray (21) including a number of wiring harness (1, 10) and a multi-tiered pallet (41) is specifically disclosed.

### FIELD OF THE INVENTION

The present invention relates to a multi-part articles fabricated using the ARMACEL (Registered Trade Mark) process. That process basically involves partially, or substantially completely, encapsulating an article with a layer, or a plurality of layers, of thermoformable plastics material.

### BACKGROUND ART

The ARMACEL process and apparatus for forming structural articles, especially from weak substrates such as polystyrene and cardboard, and articles so formed, are disclosed in the applicant's International PCT Patent Application No. PCT/AU95/00100 entitled “A method and apparatus for forming structural articles” (WO 95/23682), International PCT Patent Application No. PCT/AU96/00541 entitled “Layered Structural Article” (WO 97/09166) and International PCT Patent Application No. PCT/AU00/00250 (WO 00/59709)—the contents of all three of which are hereby incorporated into the present specification by cross reference. A further, presently unpublished specification is that of International Patent Application No. PCT/AU2004/00086 (which claims priority of Australian Patent Application No. 2003 903 211 lodged 25 Jun. 2003) which discloses the encapsulation of an interior member which is neither at least partially fluid permeable nor is perforated to become so. The disclosure of that specification is also hereby incorporated by cross-reference.

These specifications disclose forming structural articles from a shape defining interior member and at least one external skin. The basic steps of the method comprise:
1. heating a thermoformable sheet intended to form the external skin,
2. bringing the heated sheet alongside the interior member,
3. applying a fluid pressure differential between opposite surfaces of the interior member and the sheet to conform the sheet to the shape of the interior member and mutually engage same, and
4. maintaining the fluid pressure differential until the sheet has cooled.

The present invention arises as an unexpected further development of the ARMACEL process and arises in the following way. Where a single piece article is intended to be so encapsulated (whether partially or substantially completely) that article is able to be handled prior to encapsulation and, in particular, loaded into the apparatus and placed on a platen ready to be subjected to the encapsulating process.

However, where the article to be encapsulated was itself formed from several pieces, then those pieces had to be held in their intended final configuration on the platen. This could be done in two ways. One way was to form the multi-piece article into its intended final configuration before it was placed on the platen and hold the pieces together in an at least semi-permanent fashion which was sufficiently robust to enable the platen placement to be carried out. For example, articles fabricated from polystyrene or cardboard pieces would be tacked or glued together so as to form the intended final assembly. Similarly, articles fabricated from timber pieces would be nailed or possibly screwed together so as to enable the assembled article to be placed on the platen. This use of fasteners and/or gluing was relatively time consuming (particularly waiting for some glues to dry) and the fasteners and/or glue did not contribute much to the strength of the finished product (instead this was fundamentally determined by the strength arising from the encapsulation).

The other way was to assemble the multi-piece article on the platen itself. Depending upon the shape of the pieces, it was sometimes possible to allow the pieces to simply rest against each other and be held in their intended final configuration under the influence of gravity. Although this method can be successful, this course of action is fraught with the danger that the pieces may move during the application of the heated plastics skin, in which case the encapsulated article would not have the desired final configuration and would be ruined. Alternatively, the pieces could be tacked, nailed, or glued together as they were assembled on the platen. However, this was essentially not very different from the above described first way.

### OBJECT OF THE INVENTION

The object of the present invention is to find a way of increasing the rate of production of encapsulated multi-piece articles and, in particular, to avoid the disadvantages of nailing and/or gluing the various pieces together.

Unexpectedly, it has been found advantageous to utilise the ARMACEL process itself in an intermediate or preliminary step in the overall process to hold together the component pieces of some assembly or sub-assembly.

### SUMMARY OF THE INVENTION

In accordance with a first aspect of the present invention there is disclosed a process of partially, or substantially completely, encapsulating a multi-part article with one or more sheets of thermoformable plastics, said process including, as an intermediate or preliminary step, the step of at least partially encapsulating at least two of said parts with a sheet of thermoformable plastics so as to maintain said at least two parts in a predetermined relationship or configuration, and said process further including, as a step subsequent to said intermediate or preliminary step, the step of further at least partially encapsulating said at least two parts together with a further part.

In accordance with a second aspect of the present invention there is disclosed articles fabricated in accordance with the above disclosed method.

### BRIEF DESCRIPTION OF THE DRAWINGS

Embodiments of the present invention will now be described with reference to the drawings in which:

FIG. 1 is a perspective view of a first sub-assembly in the form of a wiring harness held in its final desired configuration prior to assembly,

FIG. 2 is a perspective view of a second sub-assembly (again a wiring harness) also held in its final desired configuration prior to assembly,

FIG. 3 is a side elevational view of a cable tray incorporating two of the first wiring harness sub-assemblies and a single one of the second wiring harness sub-assemblies,

FIG. 4 is a cross sectional view through the cable tray of FIG. 3,

FIG. 5 is a perspective view of four individual pieces used to construct a modular height pallet cage,

FIG. 6 is a perspective view showing the pieces of FIG. 5 in their desired final assembly configuration and immediately prior to being partially encapsulated,

FIG. 7 is a perspective view showing the completed partially encapsulated modular pallet cage prior to trimming,

FIG. 8 is an exploded perspective view showing three of the partially encapsulated modular pallet cages stacked one above the other immediately prior to being fully encapsulated, and

FIG. 9 is a cross sectional view showing a three tier encapsulated pallet cage.

### DETAILED DESCRIPTION

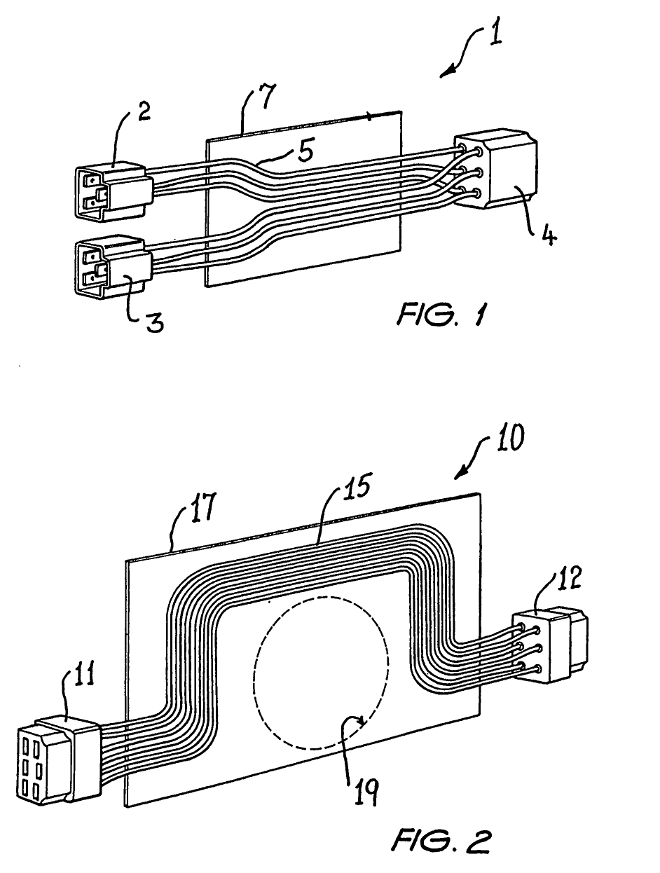

As seen in FIG. 1, a first wiring harness 1 is illustrated having two male plugs 2, 3 and a single male plug 4. The plugs 2, 3 and 4 are interconnected by means of six wires 5 which are arranged in a generally Y-shaped configuration. Whilst in the desired Y-shaped configuration the wires 5 are subjected to the ARMACEL process and thus are partially encapsulated by a sheet of plastics 7 which bonds with the wires 5 and maintains them in the desired Y-shaped configuration.

Similarly, as seen in FIG. 2, a second wiring harness 10 has two female plugs 11, 12 between which extend six wires 15 arranged in a generally U-shaped configuration. Again the wires 15 whilst in their desired U-shaped configuration are subjected to the ARMACEL process so as to be partially encapsulated by a sheet 17 of plastics material which bonds with the wires 15. After the ARMACEL process is finished the sheet 17 is trimmed so as to create a circular aperture 19 indicated by broken lines in FIG. 2.

It will be appreciated by those skilled in the wiring harness arts that the two harnesses 1, 2 can be inexpensively and easily fabricated using the ARMACEL process. In this way permanent sub-assemblies are fabricated which can be stored for later use and handled at will.

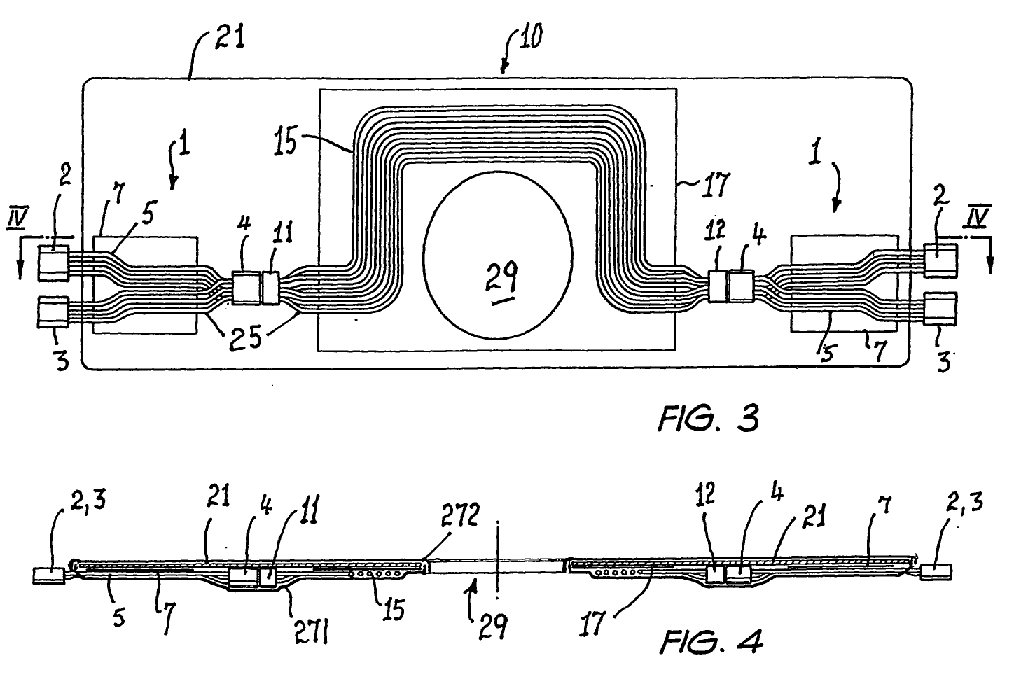

Turning now to FIG. 3, a cable tray 21 having a central aperture 29 is provided with two of the first wiring harnesses 1 and single one of the second wiring harness 10 interposed therebetween. As illustrated in FIG. 3, a desired arrangement of interconnections and layout of wires 25 is achieved. Once the harnesses 1 and 10 are laid above the cable tray 21 which is in turn located on the platen of the apparatus to carry out the ARMACEL process, and the plugs 4, 11 and 12, 4 interconnected, the entire cable tray 21 can be subjected to the ARMACEL process. This is done firstly with a sheet 271 (FIG. 4) from the side illustrated in FIG. 3 so as to partially encapsulate the wires 5, 15 and 25 and the plugs 4, 11, 12 and 4 and bond the three harnesses 1, 1 and 10 to the cable tray 21. Then the rear side (ie the side not seen in FIG. 3) of the cable tray 21 is subjected to the ARMACEL process with a sheet 272 so as to produce the final completely encapsulated cable tray as illustrated in FIG. 4.

In relation to FIG. 4, it is to be understood that the gap drawn between the individual sheets 271, 272 of plastics material is only so drawn for the purposes of illustration and does not exist in practice. Instead, the individual sheets 271, 272 are tightly drawn against, and bonded to, the adjacent objects.

It will be apparent to those skilled in the wiring arts that the cable tray 21 offers a number of various substantial advantages. Firstly, it can be made in any configuration so as to, for example, adapt to those circumstances where the central aperture 29 in the cable tray 21 is required to mate with, or allow passage through of, some other object or protrusion. In addition, the wires 5, 15 and 25 are substantially entirely encapsulated and therefore protected against any vibration, the chaffing of insulation, and like problems which beset conventional cable trays. Furthermore, the inter-engaged plugs 4, 11 and 12, 4 are likewise fully encapsulated and thus remain permanently connected with no possibility of the electrical interconnection becoming dislodged as a result of vibration. In addition, the interconnected plugs are also effectively hermetically sealed and thus their contacts are not subject to corrosion. This is a particular advantage in marine environments since many conventional electrical insulation materials are permeable to water vapour whilst the plastic sheets 7, 17, 271 and 272 are, in general, completely impermeable to moisture.

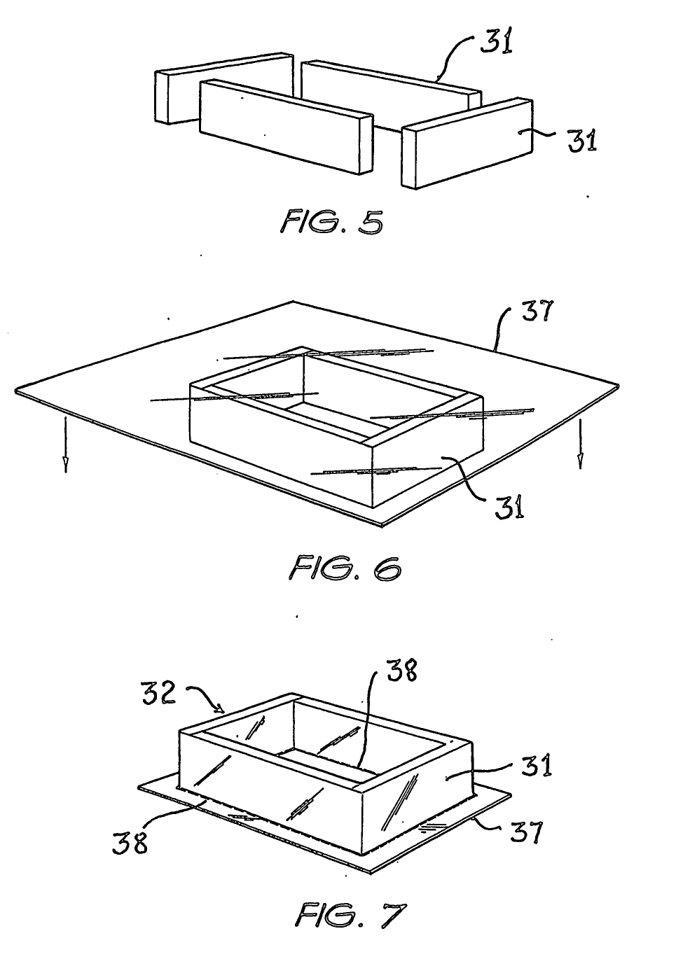

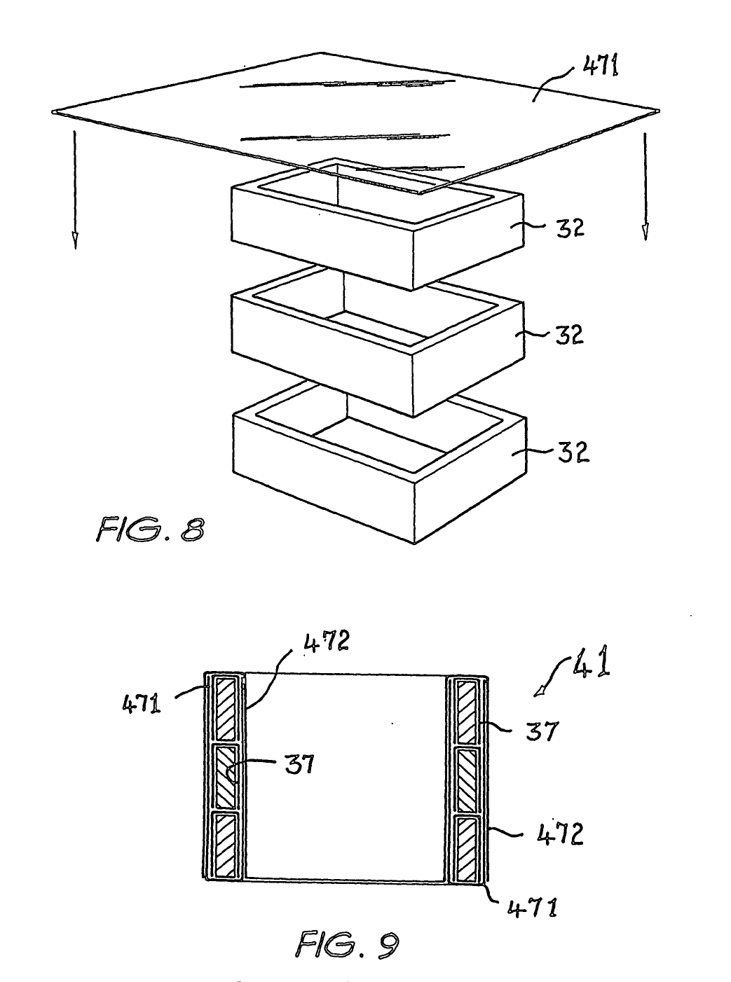

A second embodiment is illustrated in FIGS. 5-9. Here four individual rectangular slabs 31, for example of polystyrene or cardboard, are arranged to form a wall unit or tier 32 of a modular pallet cage. As illustrated in FIG. 6, the slabs 31 are placed in their final position and a sheet 37 of plastics material used to partially encapsulate the slabs 31 and retain same in their final desired position. The result of this initial application of the ARMACEL process is illustrated in FIG. 1 where the plastic sheet 37 is intended to be trimmed along the broken line 38. In this way, the four individual slabs 31 are retained in their final desired configuration as an individual wall unit or tier 32.

As seen in FIG. 8, three of the individual tiers 32 can be positioned one above the other to create a pallet cage having three times the individual tier height. Once again a plastics sheet 471 is used to initially partially encapsulate the pallet cage 41. The pallet cage 41 is then inverted and a second plastics sheet 472 used to partially encapsulate the pallet cage 41 in the opposite direction thereby leading to the final encapsulated pallet cage 41 as illustrated in FIG. 9.

It will be apparent to those skilled in the art that the use of the ARMACEL process as an intermediate or preliminary step in assembling the final object confers a number of various substantial advantages over the prior art methods of gluing or nailing a sub-assembly together. In particular, the ARMACEL process is both speedy and inexpensive and thus considerable savings in time, in particular, are able to be achieved.

The foregoing describes only some embodiments of the present invention and modifications, obvious to those skilled in the art, can be made thereto without departing from the scope of the present invention. For example, with certain configurations, assembly of the pieces of a multi-piece article without any glue, fasteners or pre-encapsulation is possible using the ARMACEL process, one embodiment of which is a nail-less pallet assembled from its constituent pieces utilising the process.

The term “comprising” (and its grammatical variations) as used herein is used in the inclusive sense of “having” or “including” and not in the exclusive sense of “consisting only of”.

1-14. (canceled)

15. A process of partially, or substantially completely, encapsulating a multi-part article with one or more sheets of thermoformable plastics, said process, comprising the steps of:
(a) at least partially encapsulating at least two parts of said multi-part article with at least one sheet of thermoformable plastics, wherein said two parts are maintained in a pre-determined configuration; and
(b) at least partially encapsulating said two parts together with an additional part of said multi-part article.

16. The process as set forth in claim 15, wherein during said step (a) said at least two parts are partially encapsulated from one side only by a single said thermoformable sheet.

17. The process as set forth in claim 16, wherein during said step (b) said at least two parts are at least partially encapsulated from a side opposite said side in said step (a).

18. The process as set forth in claim 17, wherein during said step (a) said at least two parts are at least partially encapsulated from a side opposite and from said side in said step (a).

19. The process as set forth in claim 18, wherein during said step (b) said multi-part article is substantially completely encapsulated.

20. The process as set forth in claim 19, wherein said at least two parts are at least partially encapsulated in said step (a) in a substantially planar configuration.

21. The process as set forth in claim 20, wherein said at least two parts are at least partially encapsulated in said step (b) in a substantially planar configuration.

22. The process as set forth in claim 21, wherein said at least two parts are sub-assemblies of a wiring harness.

23. The process as set forth in claim 18, wherein said at least two parts in said step (a) each have a planar configuration.

24. The process as set forth in claim 23, wherein after said step (a) a substantially annular sub-assembly is formed from said planar at least two parts.

25. The process as set forth in claim 24, wherein during said step (b) said annular sub-assemblies are least partially encapsulated to form an annular assembly.

26. The process as set forth in claim 25, wherein said annular assembly is a multi-tier pallet cage.

27. The process as set forth in claim 15, wherein said multi-part article is selected from the group consisting of wiring harnesses, cable trays, pallets, and cages for pallets.

28. A process of encapsulating a multi-part article, said process, comprising the steps of:
(a) at least partially encapsulating at least two parts of said multi-part article with a single sheet of thermoformable plastics from one side only, wherein said two parts are maintained in a pre-determined configuration; and
(b) substantially completely encapsulating said two parts together with an additional part of said multi-part article from a side opposite and from said side in said step (a).

29. The process as set forth in claim 28, wherein said at least two parts are encapsulated in said steps (a) and (b) in a substantially planar configuration, and wherein said at least two parts are sub-assemblies of a wiring harness.

30. The process as set forth in claim 28, wherein said at least two parts in said step (a) each have a planar configuration, and wherein after said step (a) a substantially annular sub-assembly is formed from said planar at least two parts.

31. The process as set forth in claim 30, wherein during said step (b) said annular sub-assemblies are encapsulated to form an annular assembly, and wherein said annular assembly is a multi-tier pallet cage.

32. The process as set forth in claim 28, wherein said multi-part article is selected from the group consisting of wiring harnesses, cable trays, pallets, and cages for pallets.

33. A partially, or substantially completely, encapsulated multi-part article comprising:
at least two parts of said multi-part article, said at least two parts being in relation to each other to form said multi-part article;
at least one sheet of thermoformable plastics at least partially encapsulating one side said at least two parts to maintain said at least two parts in a pre-determined relationship;
an additional part of said multi-part article, said additional part being in relation with said at least two parts; and
at least two additional sheets of thermoformable plastics at least partially encapsulating said encapsulated at least two parts with said additional part, one of said at least two additional sheets at least partially encapsulating a side opposite said side encapsulated by said at least one sheet of said at least two parts, and the other of said at least two additional sheets at least partially encapsulating said side encapsulated by said at least one sheet of said at least two part.

34. The process as set forth in claim 33, wherein said multi-part article is selected from the group consisting of wiring harnesses, cable trays, pallets, and cages for pallets.
